(19) United States
(12) Patent Application Publication
(10) Pub. No.: US 2006/0078307 A1
(43) Pub. Date: Apr. 13, 2006

(54) Personal video recorder method and user interface

(75) Inventor: Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,618

(22) PCT Filed: Nov. 14, 2003
(86) PCT No.: PCT/IB03/05220

§ 371 Date: Jun. 10, 2005

(30) Foreign Application Priority Data
Dec. 16, 2002 (EP) 02080311.0

(51) Int. Cl. H04N 5/91

(52) U.S. Cl. 386/107

(57) ABSTRACT

A method of recording and playing back contents to and from a personal video recorder (PVR) for audio-visual contents. The recorder comprises a storage medium (12). Information is presented concering the recorded content on said medium (12). Programmes of a first type of programmes are recorded on the storage medium (12), wherein the programmes are subscribed to by a user of the recorder. Programmes chosen by the user for viewing are played back. Programmes of a second type of programmes are recorded of said storage medium (12), wherein said second type of programmes is comprised in a user profile. Furthermore, a third type of programmes is recorded on said storage medium (12), wherein said third type of programmes comprises programmes being recommended by a broadcaster.

This invention relates in general to the field of Personal Video Recorder (PVR) systems, and more particularly to the recording and playing back of programmes to and from a PVR, and even more particularly to presentation of information by means of a user interface concerning programmes recorded on a PVR.

Personal Video Recorders (PVRs) are generally Digital Video Recorders (DVRs) having a generally non-tape based recording medium, e.g. a hard disk. PVRs can be used as conventional tape video recorders. A timer is set and thus a desired television programme is recorded on the storage medium at the time it is broadcast. An Electronic Programme Guide (EPG) is often used for automatically setting the timer of a PVR. In this case, a certain television programme on a certain television channel is chosen from an electronic list for recording. It is also common to use user preferences for automatic PVR recordings, whereby the timer settings are remotely adjusted.

PVRs are generally coupled to a broadcasting network, either via an air-interface or via a cable connection, for access to televised programmes on different television channels. A separate communication channel, e.g. via a Telephone connection, is often used to connect to an information provider to upload and/or download up-to-date information. Information on channels and transmission times for television programmes are regularly transmitted to the PVR. Information on user behaviour collected by the PVR, e.g. the frequency of recording certain type of programmes, is regularly transmitted to the information provider for processing. The television services of the information provider offered to the user of the PVR are in general services for which the PVR user has to pay for and/or subscribe to.

A number of problems are associated with the above-described conventional PVR system.

Recently, a provider of television services was signalling via the communication channel to all subscribers' PVR devices that a certain programme should be recorded and then this programme was not allowed to be deleted from the device for a certain amount of time. The broadcaster paid in this case for this service in order to promote a new television series. This resulted in massive user protests because the user had a certain programme recorded on the user's private PVR, which in many cases was not desired to be recorded. Furthermore, the user had a television programme recorded on his private PVR, which could not be deleted for a certain amount of time. This was annoying for many users who did not want to have a programme recorded on their storage medium of their privately owned PVR, in which programme they did not have any interest. The programme was taking up storage space in the PVR, which could not be used for other purposes, because it was impossible to have it deleted. The user has the perception to own the recorded programmes because they are on the private storage medium of the user.

Another problem associated with PVRs is, when the recording medium gets damaged, e.g. by a disk-crash, the recorded content is lost. This is also annoying for the user, similarly to the situation, when purchased videotapes are destroyed and thus the content is lost.

The present invention overcomes the above-identified deficiencies in the art and solves the above problems by providing a ‘Video on Demand’ system to the user of a PVR instead of the ‘Video Recorder’ system currently used. Exactly the same functions are thus provided to the user. The user will as previously be able to watch a recorded programme at an arbitrary point of time. Below the User Interface level, the PVR will be implemented in exactly the same way, i.e. by recording content to a storage medium.

Instead of allowing the user to record content from an EPG, the user is given the option to subscribe to programmes. Once the user subscribes to a programme it will be available to view for at least some time. It is reasonable from the user's point of view that a programme can only be viewed after it is first broadcast. Users are allowed to subscribe indefinitely to content e.g. by adding to a favourites list. Although the User Interface presents the concept of subscribing to a programme, this is implemented by recording the programme on a storage medium of the PVR, e.g. a hard disk.

The user is presented with a list of the programmes available to view (i.e. on the disk). This presentation can distinguish between programmes the viewer explicitly subscribed to, programmes chosen based on the user profile and other-recommended programmes (e.g. new content which the broadcaster wants to promote). The invention has thus the advantage, that the system is very user-friendly, because the user will not object to being offered the possibility to view a new series, whereas in the above described video recorder User Interface model the user did object.

Instead of allowing the user to delete programmes, the user can indicate that they are not interested, this gives the PVR the choice of whether to delete the recording or to keep it for longer.

According to aspects of the invention, a PVR system, a method, a computer-readable medium and a graphical user interface are disclosed within the scope of the inventive concept according to the appended independent claims.

According to one aspect of the invention, a method is provided. Said method is a method of recording and playing back content to and from a personal video recorder for audio-visual content, wherein the recorder has a storage medium for recording television programmes. Information is presented concerning the recorded content on said recorder. The method comprises the step of recording of programmes of at least a first type of programmes on the storage medium of the recorder, wherein said first type of programmes comprises programmes subscribed by a user of the recorder. Furthermore, the method comprises the steps of presenting of the recorded programmes in a summarised form of a User Interface, and playing back a programme chosen by the user, wherein the chosen programme is one of the above recorded programmes of at least the first type of programmes.

According to another aspect of the invention, a user interface wherein for a personal video recording system is provided, wherein information is presented to a user. The user interface comprises a first user interface for subscribing to programmes for recording. A second user interface presents the recorded programmes, wherein recorded programmes comprise at least the subscribed programmes. The user is given the opportunity to choose one of the recorded programmes for viewing on a display screen or alternatively to indicate disinterest in a recorded programme.

Preferred embodiments of the present invention will be described in the following detailed disclosure, reference being made to the accompanying drawings, in which

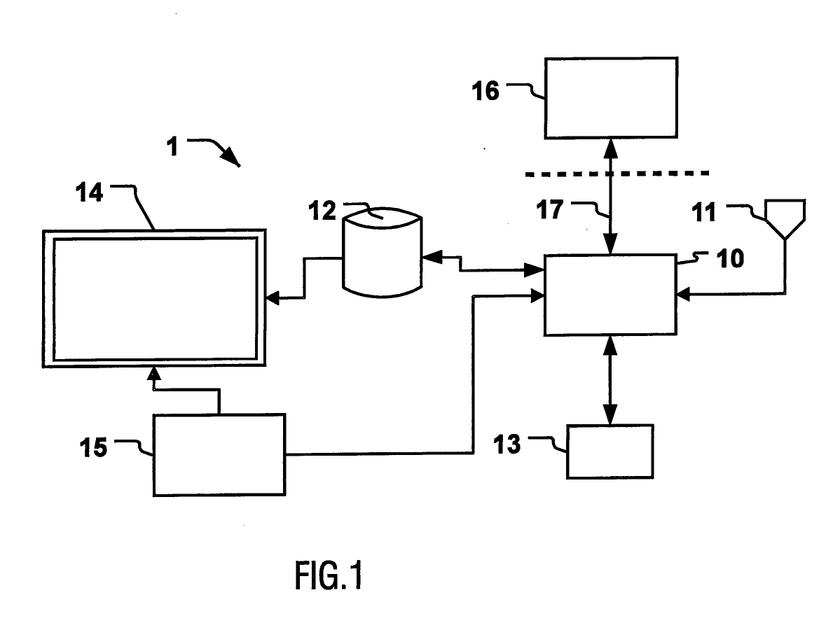

FIG. 1 shows a Personal Video Recording system, on which an embodiment of the invention is implemented,

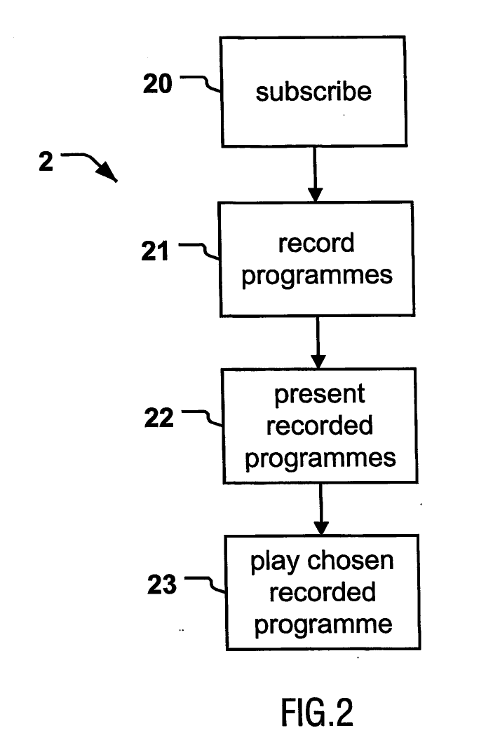

FIG. 2 is a flow chart illustration an embodiment of the invention,

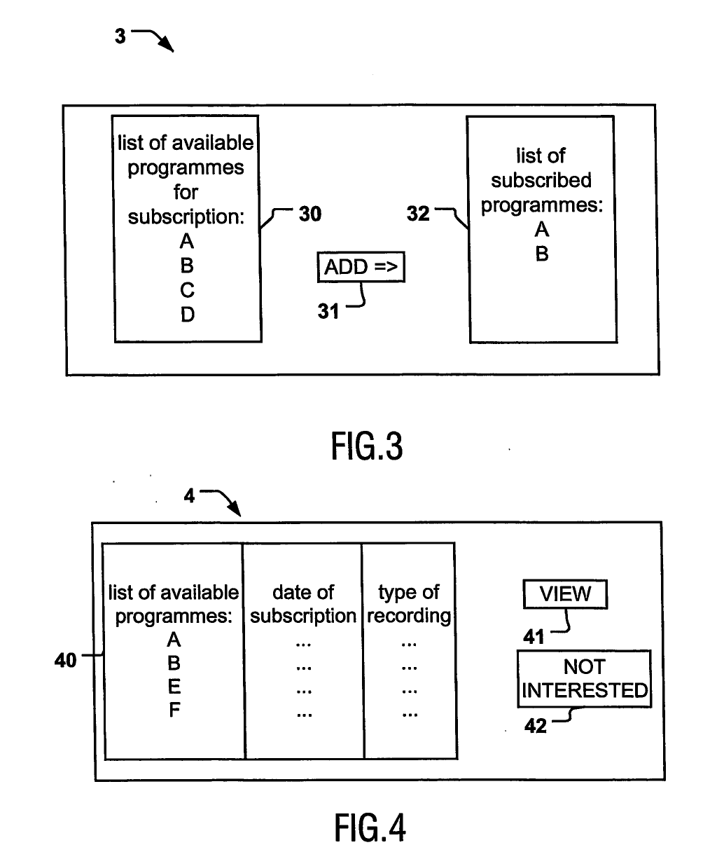

FIG. 3 is a schematic view of an embodiment of the user interface according to the invention, and

FIG. 4 is a schematic view of another embodiment of the user interface according to the invention.

A possible implementation of the invention will be described with reference to the drawing. FIG. 1 shows a PVR system 1, which is illustrative of the implementation of the invention. This system 1 comprises a processing unit 10, a broadcasting network interface 11, a storage medium 12 for storing audio-visual data, a memory for storing information about programmes to be recorded and other data such as user preferences for certain programmes, an operating panel 15, and a display screen 14. Furthermore, a television services provider 16 is shown for illustrative purposes. Television services provider 16 is not part of the system of the invention, which is indicated by the dotted line over the connection between processing unit 10 and television services provider 16.

Processing unit 10 receives and distributes information from both a user via the operating panel 15 and via operative connections to and from the storage medium 12, memory 13, television service provider 16 and from broadcast network 11. The operating panel is preferably a remote control, but can also be integrated into a PVR device or into the display screen 14. Information and/or programme content is displayed on display screen 14. Display screen 14 is also used for interacting with the user. Via a graphical user interface on display screen 14, the above-described “Video-On-Demand” method according to the invention is implemented.

According to FIG. 2, the user is in step 20 given the option to subscribe to programmes For this purpose, the user is presented a list of available programmes on display screen 14. An exemplary embodiment of the user interface 3 used for this purpose is illustrated in FIG. 3. The list of available programmes 30 for subscription is updated via a connection 17 to an external service provider 16. Subscription to a certain programme is entered via operating panel 15 and said user interface 3. In the embodiment of an user interface according to the invention, a programme is chosen from a list of programmes 30 available for subscription, in the example these are the programmes A, B, C and D. Subscription is activated by pressing a button 31, and the chosen programme is added to the list of subscribed programmes 32. In the embodiment of FIG. 3, programmes A and B are subscribed to. Once the user has subscribed to a certain programme, it will be downloaded from broadcast network 11 and be stored on storage medium 12 in step 21. The programme is then available for viewing on display screen 14. In case a broadcaster offers a service of immediate downloading, viewing is possible within a short period of time, while recording the programme. Otherwise, the programme is recorded at a later point of time, when it is transmitted at a scheduled point of time. Users are allowed to subscribe indefinitely to content e.g. by adding to a list containing favourite programmes. Although the User Interface presents the concept of subscribing to a programme, this is implemented by recording the programme on storage medium 12 of the PVR system 1. Storage medium 12 is e.g. a hard disk, a recordable digital versatile disc (DVD), or another large capacity read/write memory. Information on which programmes or type of programmes are subscribed to is stored in memory 13 and can be communicated to service provider 16.

When the user wants to watch a programme, the user is presented with a list of the programmes available to view on the storage medium 12 in step 22. An embodiment for this implementation is given in FIG. 4. Available programmes are those which are downloaded in-between the time of subscription and the time, when the user wants to watch a subscribed programme. This presentation can distinguish between programmes explicitly subscribed to by the viewer, programmes chosen based on the user profile and other recommended programmes such as new content which the broadcaster wants to promote. Field 40 on user interface 4 comprises a list of recorded programmes and further information on these programmes, e.g. their date of subscription, availability date (i.e. when the programme can be watched for the first time), type of programme, expiration dates, prices for viewing, etc. The purpose of field 40 is that the user can identify a programme for watching from a list of available programmes, whereby this either is a subscribed programme or a programme which is offered to the user for viewing based on other purposes, such as the above mentioned user profile. Two buttons 41 and 42 are available in user interface 4. Button 41 is used for choosing a certain recorded programme for viewing. With button 42, the user indicates that he is not interested in a certain recorded programme, whereby the programme can the either be deleted or be kept for another time. When the user has chosen a programme from field 40, it is played on display screen 14 in step 23.

The recordings are preferably removed after a certain time, e.g. because the storage medium runs out of free storage space, or because too long time has passed (if the recordings are only available for a certain time).

The invention has thus the advantage that the system is very user-friendly, because the user will not object to being offered the possibility to view a new series, whereas in the above described video recorder User Interface model the user did object. The invention can be compared to a video store, where recorded video media can be bought or rented. The invention offers the advantage that the user does not have to leave his home and spend time on looking for the video. Moreover, the invention is capable of supplying more up-to-date content to the user.

Instead of allowing the user to delete programmes, the user can indicate that they are not interested, this gives the PVR the choice of whether to delete the recording or to keep it for longer. The information that a user has indicated disinterest in a certain programme or type of programme, is stored in memory 13. This information is preferably used to adapt the user's profile of preferred programmes and programme types. Preferably this information is communicated to service provider 16 for further processing.

The hardware of existing PVRs does not necessarily have to be modified to implement the present invention.

Furthermore, the invention offers the advantage that the user does not have the perception that they own the content, although the content is stored on “their” storage medium. This is especially of advantage, when the storage medium gets destroyed and the stored content is lost. If e.g. a hard disk in a PVR system according to the invention crashes, the user can replace the PVR box and will be less annoyed than if they feel they have lost their content. Furthermore, the information stored in the PVR with the destroyed medium can be used to at least partly restore the former content by re-recording the programmes, e.g. when these are repeated at a later point of time.

According to the invention, the broadcaster has complete control of how the content is available. For example, in a pay-per-view system the broadcaster can charge each time a programme is watched, although the programme is already stored on the users' storage medium and does not need to be downloaded. With the conventional ‘Video Recorder’ User Interface, the user would not accept paying every time they watch something on “their” storage medium. In another implementation of the invention, broadcaster could force deletion of some content, e.g. a pre-view programme downloaded and stored on the PVR storage medium, before it is released to buy on DVD, without the user objecting.

For broadcasters who include hard disks in their Set-Top Boxes (STB), i.e. a PVR is integrated in a STB, the invention significant advantages and makes it much easier to implement alternative business models.

Preferably, the above-described PVR is integrated into a Set Top Box (STB).

Preferably, the method according to the invention is exclusively used on a PVR, thus generating a video-on-demand system.

The present invention has been described above with reference to specific embodiments. However, other embodiments than the preferred above are equally possible within the scope of the appended claims, e.g. performing the above method by hardware or software, different layouts of the described user interfaces, etc.

Furthermore, the term “comprising” does not exclude other elements or steps, the terms “a” and “an” do not exclude a plurality and a single processor or other unit may fulfil the functions of several of the units or circuits recited in the claims.

The invention can be summarised as a method of recording and playing back contents to and from a personal video recorder (PVR) for audio-visual contents. The recorder comprises a storage medium for recording television programmes. Information is presented concerning the recorded contents on said recorder. Programmes of at least a first type of programmes are recorded on the storage medium of the recorder, wherein the programmes are subscribed by a user of the recorder. In a User Interface (UI) information is in a Video-On-demand system presented concerning the recorded programmes in a summarised form. Programmes chosen by the user for viewing are played back, wherein the chosen programme is one of the above-recorded programmes. Further programmes of a second type of programmes are preferably recorded on said storage medium of the recorder, wherein said second type of programmes is comprised in a user profile of the PVR user. Furthermore, a third type of programmes is recorded on said storage medium of the recorder, wherein said third type of programmes comprises programmes being recommended by a broadcaster. The user can indicate disinterest of certain recorded programmes, wherein this information is used to update the user profile. A personal video recorder system is thus used as a video-on-demand system.

1. A method of recording and playing back content to and from a personal video recorder for audio-visual content, said recorder having a storage medium for recording television programmes, and of presenting information concerning the recorded content on said recorder comprising the steps of
recording of programmes of at least a first type of programmes on said storage medium of the recorder, wherein said first type of programmes comprises programmes subscribed by a user of the recorder,
presenting of the recorded programmes in a summarised form in a User Interface, and
playing back a programme chosen by the user, wherein the chosen programme is one of the above recorded programmes of at least said first type of programmes.

2. A method according to claim 1, wherein recording of television programmes further comprises
recording of a second type of programmes on said storage medium of the recorder, wherein said second type of programmes is on a user profile of said user, and/or
recording of a third type of programmes on said storage medium of the recorder, wherein said third type of programmes comprises programmes recommended by a broadcaster.

3. A method according to claim 2, whereby the step of presenting of the recorded programmes comprises the indication, which of the recorded programmes are based on the users subscription, based on the users profile, or recommended by a broadcaster.

4. A method according to claim 1, further comprising the step of deleting recorded programmes when the user indicates that there is no interest in viewing a certain recorded programme.

5. A method according to claim 4, whereby the recorded programmes are deleted after a certain amount of time.

6. A method according to claim 5, whereby the amount of time is controlled by the size of available storage space on said storage medium.

7. A method according to claim 4, further comprising the step of updating said user profile based on said indication information

8. A method according to claim 2, whereby said user profile for recording of said second type of programmes is adapted to the user, based on the type of subscribed programmes.

9. A method according to claim 1, whereby the step of playing back a programme is on a pay per view basis.

10. A method according to claim 2, whereby a broadcaster pays per recording of said third type of programmes.

11. A user interface for a personal video recording system, wherein information is presented to a user, said user interface comprising a first user interface for subscribing to programmes for recording, and
a second user interface presenting the recorded programmes, wherein recorded programmes comprise at least said subscribed programmes, whereby the user is given the opportunity to choose one of said recorded programmes for viewing on a display screen or to indicate disinterest in a recorded program.

12. Use of the method according to claim 1.

13. Use of personal video recorder as a system for audio-visual content available after subscription, wherein said personal video recorder is adapted to recording and playing back audio-visual content, said recorder having a storage medium for recording television programmes, wherein information is presented to a user concerning the recorded content on said recorder, wherein
programmes of at least a first type of programmes are recorded on said storage medium of the recorder, wherein said first type of programmes comprises programmes subscribed by a user of the recorder,
recorded programmes are presented in a summarised form in a User Interface, and
a programme chosen is played back by the user, wherein the chosen programme is one of the above recorded programmes of at least said first type of programmes.

14. A personal video recorder system adapted to recording and playing back of by a user subscribed audio-visual content, said recorder having a storage medium for recording television programmes, wherein in use of said personal video recorder system:
programmes of at least a first type of programmes are recorded on said storage medium of the recorder, said first type of programmes being programmes subscribed by a user of the recorder,
information concerning the recorded content on said recorder system is presented to a user on a display device, and
a programme chosen by said user is played back by the user,
wherein the chosen programme is one of the above recorded
programmes of at least said first type of programmes.
